(19) United States
(12) Patent Application Publication
(10) Pub. No.: US 2024/0087062 A1
(43) Pub. Date: Mar. 14, 2024

(54) REAL ESTATE ASSET FEASIBILITY ANALYSIS SYSTEM AND METHOD

(71) Applicants: Maurice Woolf, West Hollywood, CA (US); Bethany Woolf, West Hollywood, CA (US)

(72) Inventors: Maurice Woolf, West Hollywood, CA (US); Bethany Woolf, West Hollywood, CA (US)

(21) Appl. No.: 18/243,545

(22) Filed: Sep. 7, 2023

Related U.S. Application Data
(60) Provisional application No. 63/404,901, filed on Sep. 8, 2022.

(51) Int. Cl. G06Q 50/16

(52) U.S. Cl. CPC G06Q 50/165

(57) ABSTRACT

A real estate feasibility analysis system includes a geospatial data server that receives and publishes parcel information, an elevation data converter that generates elevation slope bands, and a real estate analysis engine that receives the parcel information and the elevation slope bands, determines that a parcel of real property is located within the geographical location, determines slope band parcel ratios of the parcel using the parcel information and the elevation slope bands, and determines a maximum buildable area using the slope band parcel ratios of the parcel. The system may also determine a maximum opportunity area associated with the parcel, and determine a maximum build score associated with the parcel, wherein the maximum build score is represented by a ratio of the maximum opportunity area to the maximum buildable area.

This application claims the benefit of U.S. Provisional Patent Application No. 63/404,901 filed on Sep. 8, 2022, the entirety of which is incorporated by reference herein.

### FIELD OF THE INVENTION

### Field of the Invention

The present invention relates generally to real estate valuation, and more particularly, to a real estate asset feasibility analysis and method.

### Background of the Invention

Traditional real estate valuation includes a “neighborhood comp” analysis of surrounding properties and their sales prices in order to provide a current value of the target property, generally based a “price per square foot basis” of the nearby homes. Though the current methodology may provide limited benefits for some newer homes on standardized lots, these basic algorithms and averages severely underserves homes that sit on larger lots and/or those that may have development potential. With a traditional neighborhood comp analysis, an older, smaller property with deferred maintenance would be “comped” against a nearby sold property, with the price adjusted downward to account for its current, sub-par condition. The lot size, shape, orientation, and zoning would likely not be factored in. As a result, the home would likely be valued for less and the homeowner would not have accurate analysis of the property's worth to someone who is not concerned for what it is now, but interested in optimizing the structure and/or land for profit. These traditional valuations are therefore limited in that they do not take into account future value-add potential, such as the potential development opportunities presented by small structures on larger lots, older homes with deferred maintenance and/or outdated floorplans, or those failing to take advantage of naturally occurring characteristics of the land (e.g., waterfronts, views, hillsides, etc.), outdated and less desirable properties in neighborhoods experiencing gentrification where market values are rising, and distressed properties. While rudimentary analysis of future development potential exists, there is a need for a comprehensive system and method to identify potential development opportunities, analyze public and proprietary datasets, and create uniform valuation metrics and calculations to inform buyers, sellers, and real estate developers on the future value potential of properties while accounting for factors not utilized in traditional valuations.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

The present invention includes a system and method for real estate feasibility analysis. The system preferably includes a cloud-based property software platform that identifies certain properties such as Multiple Listing Service (“MLS) Off-market, for-sale-by-owner (“FSBO”), for-rent-by-owner (“FRBO”), real-estate owned (“REO”), expireds, and foreclosures for their potential maximum buildable area. Thus, the present invention includes a property software platform that identifies properties for their value-add potential. These properties may include, but are not limited to, older homes with deferred maintenance, distressed properties, and small properties on large lots, where larger homes may be built on large lots based on allowable floor area ratios. These properties are analyzed to determine the maximum buildable area by retrieving and processing public records along with proprietary datasets to reveal the property's highest and best use.

In a preferred embodiment, the present invention maps certain parameters over the allowable zoning regulations per city or county, against a slope band analysis, and calculates the opportunity score (referred to as a “max-build score” or “Maximum Build Score”). Allowable zoning regulations per city or county may include Residential Floor Area Ratios (“RFAR”), lot coverage, code narrative for setbacks and height regulations and in hillside properties, calculated in accordance to the degree of slope relative to each band in a slope band analysis. This triangulated data outputs a Maximum Build Score and Maximum Renovation Score. The Maximum Build Score/Maximum Renovation Score demonstrates how much square footage one can build for a new construction or how much can be added for a renovation in one statistic. In some areas, new construction receives a bonus in allowable square footage if certain parameters are met. In these renovation opportunities, the opportunity score for a Maximum Build could be different than the opportunity score for a Maximum Renovation. This helps to provide context about the best way to leverage the highest best use of a value-add property. In areas where there is no bonus for new construction, the Maximum Build Score is shown. The methodology for determining a Maximum Build Score and a Maximum Renovation Score is more fully described herein. Generally, the more construction that can be built, the higher the Maximum Build Score and, thus, the larger the development opportunity. Once a user can understand a property's development standards, they can analyze the market for that proposed development, comp out the finished development's value and then complete an investment proforma to determine the development viability and estimate profit. The present system and method involves analyzing a property for what it could be—the “hidden value.” By analyzing a property's land use and development potential, then packaging the home for its future development value and selling it to the buyer group that values this type of project, homeowners can negotiate a better price and terms than the traditional comping and selling method. Buyers interested in optimizing land to create more housing (and more modern housing) benefit from the feasibility analysis and opportunity report disclosed herein to make better, faster and more efficient investment choices.

The users may include real estate brokerages, buyers, sellers, real-estate agents and/or brokers, and real-estate developers, among others. These users, now knowing the hidden value of real estate, may avoid valuing property at sub-optimum sales prices by factoring in zoning and maximum building allowances and entering into uninformed and lopsided negotiations. The system and method disclosed herein educates users on the hidden value such that the users may conduct more fair negotiations over the real value of the properties. Knowledge of the hidden value may empower sellers to earn a better sales price while benefiting developers and other buyers with better and more consistent deal flow. Agent or brokerage users may garner better relationships, provide more value to clients, transact more sales and build better pipelines of sales.

In an embodiment, the system analyzes public records along with proprietary datasets for a property's highest and best use. It maps these parameters over the allowable zoning regulations specified by city and calculates an opportunity score (Maximum Build Score or Maximum Opportunity Score) by looking at how much may be constructed on top of what is already built on the plot of land. The regulations take into consideration zoning parameters but also RFAR, lot coverage, code narrative for setbacks and height regulations and in hillside properties, calculated in accordance to the degree of slope relative to each band in a slope band analysis. Depending on the city and/or county in which the subject property is located, some or all of this information may be available, and the system accommodates the many variations that exist by city, county, or municipality. Thus, the system not only obtains the data from the pertinent databases, but after obtaining the data, analyzes and converts the data into meaningful information, adapting to the varying amounts of data obtainable from the city, county, municipality, and local neighborhood regulations. In a preferred embodiment, the greater amount of construction that may be built on a property, the higher the maximum buildable opportunity, and thus, the higher the Maximum Build Score. The Maximum Build Score can assist the user to easily identify parcels or lots with high potential for development or “hidden value.” Each city's zoning regulations are mapped into the codebase so that the maximum square footage allowed for any property a particular county may be calculated. The property is matched with the correct zone by placing the property coordinates on top of a zoning shapefile. In addition, proprietary hillside algorithmic calculations used for calculating the floor area ratios are utilized, obtained by using an altitude contour shapefile such as, for example, Los Angeles Region Imagery Acquisition Consortium (“LARIAC”) data, which in turn is utilized to calculate slope bands. In an embodiment, the shapefile is converted using a geographic mapping and analysis tool such as, for example, Aeronautical Reconnaissance Coverage Geographic Information System (“ArcGIS”), in order to obtain slope band percentages by area. For example, in Los Angeles County, five intervals are specified, whereas in San Diego County, four intervals are specified. For each property the plot is placed as a layer on top of the shapefile layer in order to see the square footage of each of these slope band intervals.

In accordance with an aspect of the present invention there is provided a real estate feasibility analysis method. Elevation data is received corresponding to a geographical location, wherein the elevation data includes altitude contours defined by horizontal and vertical coordinates within the geographical location. Parcel information is received that includes coordinate information defining boundary and structure information associated with the parcel and any structures thereon. A parcel of real property is determined to be located within the geographical location using the parcel information. The elevation data is converted to elevation slope bands for each of the altitude contours associated with the parcel. Slope band parcel ratios of the parcel are determined using the parcel information and the elevation slope bands, wherein the slope band parcel ratios indicate a percentage of area of the parcel associated with each of the elevation slope bands. A maximum buildable area is determined using the slope band parcel ratios of the parcel.

A maximum opportunity area associated with the parcel may be determined, wherein the maximum opportunity area includes the difference between the maximum buildable area and a structural area determined from the structure coordinates of the parcel. A maximum build score associated with the parcel may be determined, wherein the maximum build score is represented by a ratio of the maximum opportunity area to the maximum buildable area.

The parcel information may include parcel regulations including at least one of zoning parameters, residential floor area ratio regulations, lot coverage restrictions, setback regulations, land use regulations, height restrictions, map-based boundary data, property ownership data, building footprint data, interior room boundary data, assessor data, and multiple listing service data. The slope band parcel ratios may be reduced by a magnitude to which the parcel regulations restrict building on the slope band parcel ratios, for each of the slope band parcel ratios. The parcel information may also include zoning incentives, wherein the slope band parcel ratios are increased by a magnitude to which the zoning incentives permit additional building on the slope band parcel ratios, for each of the slope band parcel ratios.

A feasibility analysis including the maximum build score may be provided. A return on investment data and annual internal rate of return based at least in part on the maximum build score may be determined. An opportunity report that includes at least one of the return on investment data and the annual internal rate of return may be provided.

The maximum buildable area may include at least one of a new construction buildable area and a renovation buildable area such that the maximum build score is represented by a maximum new build score and a renovation build score. The maximum build score, the parcel information, and a three-dimensional representation of the parcel and the slope bands parcel ratios may be displayed. The geographical area may be a city and/or a county. The elevation data may be segregated by altitude interval.

In accordance with another aspect of the present invention there is provided a real estate feasibility analysis system that includes a geospatial data server configured to receive and publish parcel information that includes coordinate information defining boundary and structure information associated with the parcel and any structures thereon, an elevation data converter configured to receive elevation data corresponding to a geographical location, wherein the elevation data includes altitude contours defined by horizontal and vertical coordinates within the geographical location, to generate elevation slope bands from the elevation data, and to provide the elevation slope bands to the geospatial data server, and a real estate analysis engine configured to receive the parcel information and the elevation slope bands from the geospatial data server, determine that a parcel of real property is located within the geographical location using the parcel information, determine slope band parcel ratios of the parcel using the parcel information and the elevation slope bands, wherein the slope band parcel ratios indicate a percentage of area of the parcel associated with each of the elevation slope bands, determine a maximum buildable area using the slope band parcel ratios of the parcel, determine a maximum opportunity area associated with the parcel, wherein the maximum opportunity area comprises the difference between the maximum buildable area and a structural area determined from the structure coordinates of the parcel, and determine a maximum build score associated with the parcel, wherein the maximum build score is represented by a ratio of the maximum opportunity area to the maximum buildable area.

In accordance with another aspect of the present invention there is provided a real estate feasibility analysis method. Elevation data corresponding to a geographical location is received, wherein the elevation data includes altitude contours defined by horizontal and vertical coordinates within the geographical location. Parcel information corresponding to a parcel of real property located within the geographical location is received, the parcel information comprising coordinate data defining boundary and structure information associated with the parcel and any structures thereon, zoning parameters, residential floor area ratio regulations, lot coverage restrictions, setback regulations, land use regulations, height restrictions, map-based boundary data, property ownership data, building footprint data, interior room boundary data, assessor data, and multiple listing service data. The elevation data is converted to elevation slope bands for each of the altitude contours associated with the parcel. Slope band parcel ratios of the parcel are determined using the parcel information and the elevation slope bands, wherein the slope band parcel ratios indicate a percentage of area of the parcel associated with each of the elevation slope bands, wherein the slope band parcel ratios are reduced by a magnitude to which the parcel regulations restrict building on the slope band parcel ratios, for each of the slope band parcel ratios. A maximum buildable area is determined using the slope band parcel ratios of the parcel.

A maximum opportunity area associated with the parcel may be determined, wherein the maximum opportunity area includes the difference between the maximum buildable area and a structural area determined from the structure coordinates of the parcel. A maximum build score associated with the parcel may be determined, wherein the maximum build score is represented by a ratio of the maximum opportunity area to the maximum buildable area.

### BRIEF DESCRIPTION OF THE DRAWINGS

The invention may be more readily understood by referring to the accompanying drawings in which:

FIG. 1 is a system block diagram of a real estate feasibility analysis system in accordance with a preferred embodiment of the present invention;

FIG. 2 is a diagram of a real estate feasibility analysis system in accordance with a preferred embodiment of the present invention;

FIG. 3 is a diagram of a real estate feasibility analysis system in accordance with a preferred embodiment of the present invention;

FIG. 4 is a user interface of a real estate feasibility analysis system in accordance with a preferred embodiment of the present invention;

FIG. 5 is a is a diagram of a real estate feasibility analysis system in accordance with a preferred embodiment of the present invention; and

FIG. 6 is a flowchart of a real estate feasibility analysis method in accordance with a preferred embodiment of the present invention.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

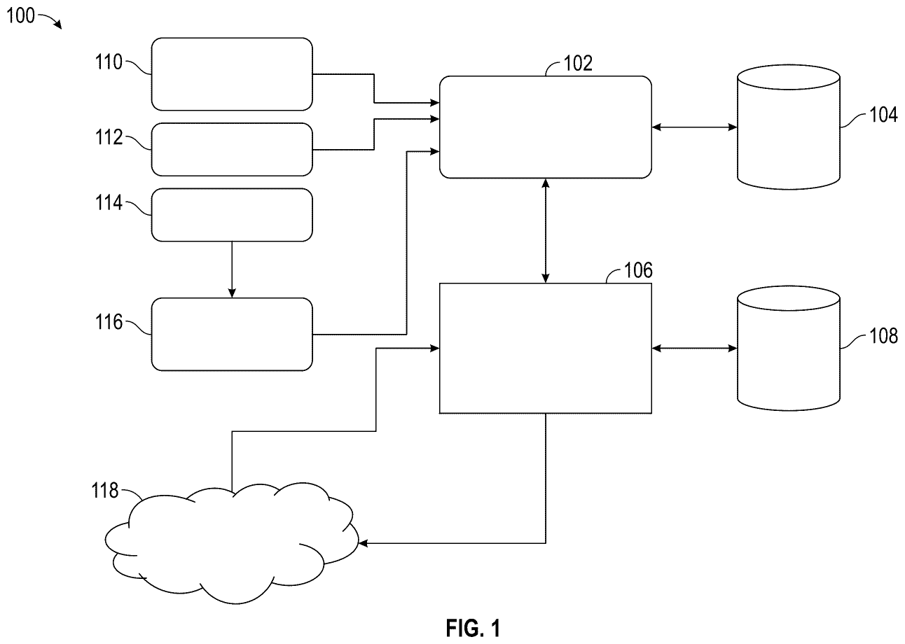

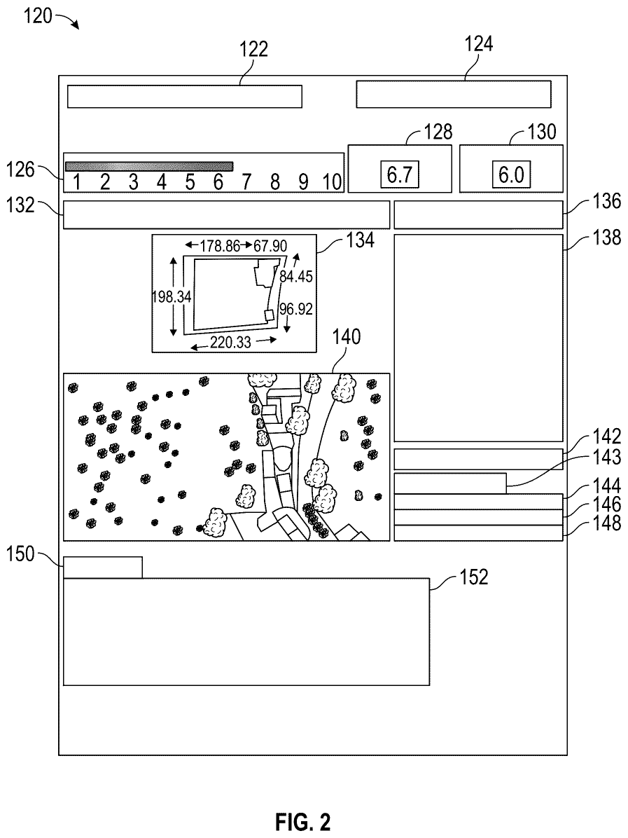

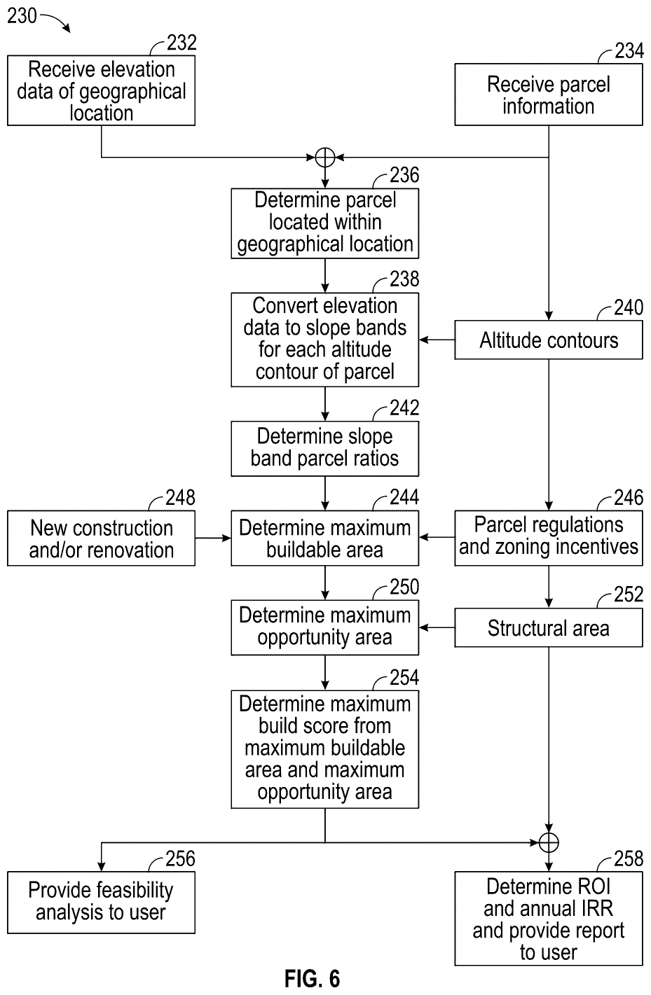

Referring now to the drawings, which are for purposes of illustrating the present invention and not for purposes of limiting the same, the drawings show devices and components (and related methods) therein in accordance with preferred embodiments of a real estate asset feasibility analysis system and method. As shown in FIG. 1, the real estate asset feasibility analysis system generally includes a system of interconnected databases, information sources, and processing modules configured to generate the maximum buildable area and property opportunity scores to allow users to identify and maximize the highest and best use of the property in question. As shown in FIGS. 2-5, the real estate feasibility analysis system includes algorithmic computations, determinations, and scoring to assist buyer, seller, agent, and/or developer in determining the value of new construction and/or renovation of property, as well as a user interface configured to generate feasibility analyses and opportunity reports. As shown in FIG. 6, a real estate feasibility analysis method is shown that illustrates an exemplary process in accordance with preferred embodiments of the present invention.

Generally, the real estate feasibility analysis system, in an embodiment, includes a computing system, an application stored thereon, a database, and a network configured to facilitate communication between the computing system and the database. The computing system may be a cloud-based computing system. The computing system may include the database. The computing system may be configured to operate a software application. In other embodiments, the application is implemented on a web browser utilizing a programming language suitable for web-based software. As disclosed herein, a variety of programming or scripting languages may be utilized to implement the application and/or software modules.

Referring now to FIG. 1, FIG. 1 discloses a real estate asset feasibility analysis system 100 in accordance with a preferred embodiment of the present invention. The system includes a geoserver 102, a postgreSQL database 104, an application platform 106, a mySQL database 108, a public database 110, a non-public database 112, an elevation shapefile database 114, an elevation shapefile converter 116 and a user interface 118. One of ordinary skill in the art would understand that while these exemplary features are listed, other features are possible in accordance with preferred embodiments of the present invention.

The geoserver 102 is preferably a geospatial data server configured to receive and publish geospatial data. In a preferred embodiment, the geoserver 102 is Geoserver, a server written in Java that allows users to share, process and edit geospatial data. In other embodiments, the geoserver 102 is another server configured to share, process, and edit other geospatial data such as ArcGIS and QGIS, or the like. The geoserver 102 is configured to receive, process, and edit shapefiles including information such as building/parcel, zoning, elevation, and related metadata. In an embodiment, for example, the metadata may include information about the current owner, the property's building history, and other pertinent information about the property.

The geoserver 102 in an embodiment can receive and publish both vector and raster data. Vector data is a coordinate-based data model that represents geographic features as points, lines, and polygons. Each point feature is represented as a single coordinate pair, while line and polygon features are represented as ordered lists of vertices. Attributes are associated with each vector feature. Raster data, on the other hand, is a spatial data model organized into a matrix of equally sized cells, or pixels, and arranged in rows and columns, composed of single or multiple bands. Each cell contains a numeric value representing information such as temperature at a particular height or depth, elevation, or image brightness value. The scale can be nominal, ordinal, interval, or ratio. Raster coordinates are contained in the ordering of the matrix. Groups of cells that share the same coordinate value represent the same geographic feature.

In this embodiment, the geoserver 102 is configured to store and communicate and/or retrieve data from the postgreSQL database 104. The postgreSQL database 104 is a relational database management system with structured query language (SQL) compliance. One of ordinary skill in the art would be familiar with postgreSQL and SQL. Database management systems other than postgreSQL may also be utilized without departing from the scope of the present invention. For example, MySQL and MSSQL may be used as the database management system in place of the postgreSQL database 104.

Referring still to FIG. 1, the geoserver 102 is further configured to receive and store data from the public database 110 and the non-public database 112. Preferably, the geoserver 102 receives public and non-public shapefiles from the public database 110 and the non-public database 112. One of ordinary skill in the art would understand that a shapefile is a vector data storage format for storing the location, shape, and attributes of geographic features, generally configured to be utilized in geographic information system (GIS) software.

As an example, the public database 110 stores city office/buildings/parcels shapefiles (i.e., parcel shapefile) that are configured and available to be retrieved by the geoserver 102. The parcel shapefile is obtained from a specified city office and is generally publicly available. The city office/buildings/parcels data obtained through the parcel shapefile includes map-based boundaries, property ownership, land use, building footprints, and like information. For example, the parcel shapefile includes mapping of coordinates for boundary lines, with points along the border for defining the boundary lines of a parcel. The parcel shapefile may also include boundaries for rooms within a building. Parcel shapefiles are utilized to see the coordinates and shape of all parcels and buildings, including room partitions therein.

In addition, the public database 110 may store zoning shapefiles. The zoning shapefile in an embodiment is obtained from a specified city and/or county office and is generally publicly available. The city or county zoning information may include allowable zoning regulations per City or County, Residential Floor Area Ratios (“RFAR”), lot coverage, code narrative for setbacks and height regulations and in hillside properties, calculated in accordance to the degree of slope relative to each band in a slope band analysis. The zoning data obtained through the zoning shapefile includes zoning information for particular parcels of land. For example, the City of Los Angeles has established a set of zoning regulations that limit the ways in which a parcel of land within the city limits may be used, including limitations on the scale and size of development, square footage, allowable intensity/density of the use, and in some cases, specialized or tailored zoning regulations for particular areas of the city (e.g., historic district, Residential Floor Area (“RFA”) District, height district, Interim Control Ordinances (“ICOs”), proximity to elementary school, etc.). One of ordinary skill in the art would understand that other types of regulations not mentioned herein are within the scope of the present invention. In addition, similar to the City of Los Angeles, Los Angeles County has established a set of regulations that lists allowable uses and design requirements, and limitations on development of a parcel within that particular zoning area. In each regulation, the city or county may specify a particular type of zoning by letter and number (e.g., R1 relating to single-family dwellings). In an embodiment, the geoserver 102 is also configured to receive, process, and edit zoning regulations (e.g., not specific shapefiles) from the governing agency for the city or county. For example, in addition to the zoning information for particular parcels of land, zoning regulations (obtained from each city office) are normalized into code; the normalized code is utilized, in part, to calculate the max build for parcels (described in more detail below), and to show the code narrative in analysis to the user. In addition to zoning regulations, land use regulations also may be retrieved from public or non-public databases 110, 112 for use by the geoserver 102 and/or normalized into code for use by the geoserver 102 and/or the application platform 106. Land use regulations differ from zoning regulations and may determine how non-city or unincorporated land may be developed. For example, Los Angeles County includes unincorporated land outside the City of Los Angeles that is subject to land use regulations. Zoning and land use regulations also typically specify the process whereby a potential developer may seek review and approval for proposed development. This may be utilized by the system and method herein by determining an amount of time necessary to factor in for development purposes, as the review and approval process may take significant time to accomplish and may affect the timeline to start construction on a parcel.

Further, the public database 110 may store elevation shapefiles. Alternatively, the elevation shapefile database 114 stores the elevation shapefiles. In an embodiment, the elevation shapefile is obtained from a city and/or county office and is generally publicly available. As shown in FIG. 1, the elevation shapefile is retrieved from the elevation shapefile database 114 and is converted to slope bands (e.g., elevation slope bands) using the elevation shapefile converter 116 and input into the geoserver 102. Preferably, the elevation slope bands are stored in the postgreSQL database 104 for retrieval by the geoserver 102. In other embodiments, however, the geoserver 102 retrieves the elevation slope bands from the application platform 106. The elevation slope bands preferably is converted from a contours shapefile (e.g., altitude contours defined by horizontal and vertical coordinates within the geographical location).

Other shapefiles and/or other data are within the scope of the present invention, including building/parcels information, zoning information, elevation information for particular parcels of land, and land use regulations, among others. These shapefiles and/or other data may be publicly or privately available, or a combination of both, all within the scope of the present invention. One of ordinary skill in the art would understand that while shapefile datasets are disclosed in connection with FIG. 1, other embodiments may utilize other data formats configured to identify information about buildings/parcels, such as in GeoPackage, GeoJSON, CSV and SQL formats. While the prior discussion related to publicly available databases (e.g., public database 110), the non-public database 112 may store the aforementioned data and shapefiles. For example, assessor data and MLS listings may be stored in the database and retrieved to be processed. In addition, parcel coordinate point information may be obtained from third parties, based on the parcel address. These sources may not be (or are not) publicly available.

In an embodiment, the application platform 106 depicted in FIG. 1 is a cloud-based platform built in hypertext preprocessor (PUP), a general-purpose scripting language geared toward web development, using Laravel. One of ordinary skill in the art would understand that Laravel is a PUP web framework intended for the development of web applications following the model-view-controller architectural pattern. An application associated with the application platform is configured to receive the information stored on the postgreSQL database 104 via the geoserver 102, and perform calculations to be used in determining metrics and calculations to be used by would-be purchasers, sellers, and developers of parcels of land. In an embodiment, the application platform 106 itself is configured to run on a Linux virtual machine (with CentOS), but may be implemented in a variety of other computing systems and/or operating system environments. The application platform is configured to utilize a MySQL database 108 for database management and storage. One of ordinary skill in the art would understand that MySQL is a relational database management system based on and compliant with SQL.

As described above, the application platform 106 is preferably utilized to generate metrics and algorithmic calculations to be utilized by a user interested in the development potential of a parcel. For example, the application platform 106 produces an analysis that graphically illustrates feasibility analysis and algorithmic conclusions based on the methods disclosed herein to help determine development potential of a parcel. For example, the analysis integrates zoning and/or land use information, slope data, shapefiles and assessor data to reveal a maximum buildable area, a maximum opportunity area, and a maximum build score. As described herein, in an embodiment, the city or county zoning information includes allowable zoning regulations per city and/or county, RFARs, lot coverage, code narrative for setbacks and height regulations, and in hillside properties, calculated in accordance to the degree of slope relative to each band in a slope band analysis. The analysis preferably details an overview of the current property characteristics, such as zoning, code narrative, and slope band analysis. The analysis also preferably provides 2D images to demonstrate the width and depth measurements of the lot and buildable area after required setbacks. Further, the 3D graphic images of the parcel preferably illustrate slope band calculations. The 3D images also represent the existing size, shape of the house and its location and orientation on the lot, relative to the topography. For example, information retrieved from the public database 110 and the non-public database 112 is utilized for the 3D model and matches the parcel with the zoning shapefile and elevation (e.g., slope bands) shapefile to calculate the maximum build score and graphically illustrate the effect of the elevation profile of a hillside property, for example. The analysis, calculations, and images are generated using the application platform 106 in connection with the system and method disclosed herein. The user interface 118 is utilized to depict the analysis, calculations, algorithmic conclusions, and images to a user.

In a preferred embodiment, the analysis is a feasibility analysis that provides a maximum build score (e.g., maximum build opportunity score) and illustrates a maximum build allowance on real estate parcels or property using slope data and other property information. A report may also be generated that preferably provides a full study of a development project and market analysis, including an evaluation of the “future value” of real estate parcels or property. In addition, the report includes a feasibility analysis similar to that described above in connection with a maximum build score, but provides a maximum renovation or rehabilitation score (e.g., renovation opportunity score). The renovation opportunity score assumes that the existing structure is not torn down and remains while the additional square footage is utilized for renovation.

While a feasibility analysis and/or report is identified as providing the real estate feasibility analysis to the user, other methods or systems of providing the analysis to the user are within the scope of the present invention. For example, as shown herein, the user interface 118 includes a hierarchy of available analysis tools generally relating to the features of the analysis, as described herein, but are separately viewable, along with additional data and analysis to assist the user in determining building or renovation opportunities.

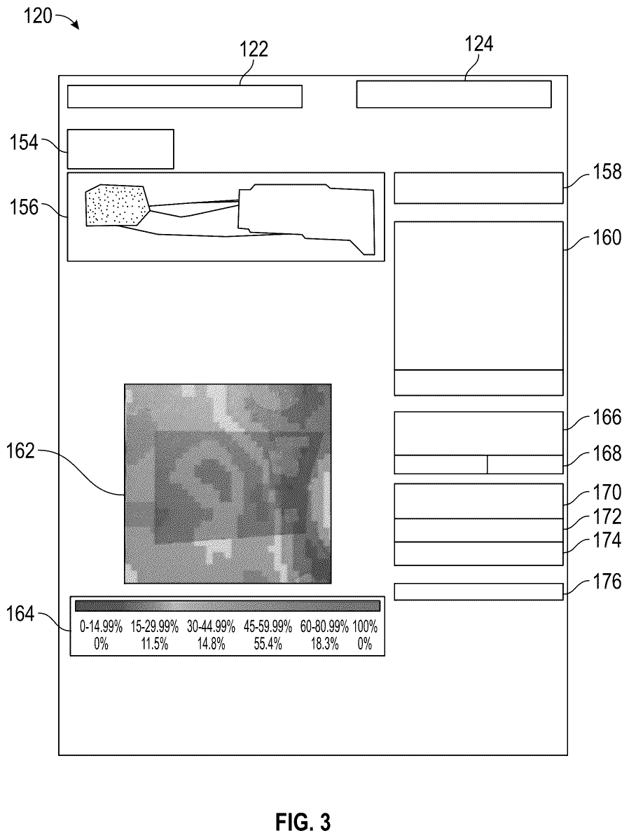

FIGS. 2-3 illustrate an exemplary real estate feasibility analysis 120 in accordance with a preferred embodiment of the present invention. Referring now to FIG. 2, there is identified a title 122, a subject address 124, an opportunity score graph 126, a maximum opportunity score 128, a renovation opportunity score 130, a parcel summary 132, a lot dimension graphic 134 (e.g., 2D graphic), a current property specification table 136, a specifications table 138, a lot lines map 140, a proforma build calculation table 142, a floor area ratio 143 (e.g., RFAR), a maximum build area 144, a maximum renovation area 146, an add-on area 148, a code narrative 150, and a code specification table 152.

The subject address 124 preferably describes the address, city, and location of the property to be analyzed. The opportunity score graph 126 is a graphical representation of the maximum opportunity score 128 and/or the renovation opportunity score 130, provided in a scale of 1-10 for ease of analysis and review. The maximum opportunity score 128 (e.g., maximum build score) preferably determines a maximum build opportunity on the parcel associated with the subject address 124, assuming that any preexisting structures are demolished and new construction/development is undertaken. For example, a buyer or developer seeking to build new construction on an existing parcel would benefit from the maximum opportunity score 128, as they would be able to gauge a higher opportunity from a lower opportunity based on the score (e.g., from 1-10). The higher the maximum opportunity score 128, the better the opportunity.

The renovation opportunity score 130, similarly to the maximum opportunity score 128, provides a buyer or developer seeking to renovate or add on to an existing structure of a parcel with a method by which to gauge a higher opportunity from a lower opportunity. The renovation opportunity score 130 takes into account the preexisting structure size in square footage and assumes that the buyer or developer does not wish to tear down or demolish the preexisting structure on the parcel.

The parcel summary 132 depicts a summarized version of the current property specification table 136 with the specifications table 138. For example, the parcel summary 132 recites “Dwelling built in 1962; Area: 3582 Sq. Ft.; Bedrooms: 3; Bathrooms: 3”. The lot dimension graphic 134 is a 2D representation of the parcel with coding based on the information contained in the specifications table 138, for example, including setbacks, restricted zones, etc. It may also provide dimensions of the buildable area in the parcel and the preexisting structure. The current property specification table 136, in combination with the specifications table 138, preferably provides, in table format, the APN (assessor parcel number), zone (e.g., RE20-1-H-HCR), existing build (3,582 sq. ft.), lot area (42,726 sq. ft.), frontage width (e.g., 97 sq. ft.), lot depth (e.g., 220 ft), front yard setback (e.g., 25 ft), side yard setback (e.g., 10 ft), back yard setback (e.g., 25 ft), specific plan (e.g., Hillside Construction Regulation District), historic (e.g., “yes” or “no”), slope (e.g., “yes” or “no”), and the like.

The lot lines map 140 preferably depicts a 2D representation of the parcel and its surroundings, including all structures, with a boundary line depicting the lot lines of the parcel. For example, the application platform obtains city/county/land use data that is used to determine boundary lines of the parcel to generate the 2D graphic with the preexisting structures identified as greyed-out portions of the 2D graphic. The proforma build calculation table 142 preferably depicts lot restrictions and algorithmic calculations of the parcel, including the floor area ratio 143, the maximum build area 144, the renovation build area 146, and the add-on area 148. The floor area ratio 143 identifies, in ratio format, the measurement of a structure's floor area in relation to the size of the parcel on which the structure is located. For example, the floor area ratio 143 is 0.35:1, and is typically preset by the city or county in which the parcel or lot is located. The maximum build area 144 identifies the maximum square footage of area that may be built on the parcel or lot. For example, the maximum build area 144 takes into account the effect of slope on build area along with any RFAR bonus, as described herein. The renovation build area 146 identifies the square footage of area that may be included as a renovation on the parcel or lot. The add-on area 148 identifies the square footage of area available to construct add-ons on the parcel or lot. Determination of the maximum build area 144, renovation build area 146, and add-on area 148 are described below.

The code narrative 150, in combination with the code specification table 152, specifies city and code regulations (or any land use or other regulations) that impact the availability to build on the parcel or lot. For example, the code specification table 152 includes the front yard setback (e.g., 20% lot depth; 25 ft maximum, but not less prevailing), side yard setback (e.g., 10 ft), back yard setback (e.g., 25% lot depth; 25 ft maximum), Floor Area Ratio (FAR) (e.g., 0.35:1), parking (e.g., 2 covered spaces per dwelling unit; bicycle parking pursuant to Sec. 12.21 A.16 of the LAMC), and height (e.g., roof≥25%; 36 ft; roof≥25%; 30 ft, stories: n/a).

The maximum opportunity score 128 (e.g., maximum build score) is calculated using the following equations:

$$Opportunity Area = Maximum Build Area - Structure Size$$

$$Maximum Build Score = ( \frac{Opportunity Area}{Maximum Build Area} ) \times 10$$

The Opportunity Area is calculated by subtracting the Structure Size (e.g., existing build from specifications table 138) from the Maximum Build Area (e.g., maximum build area 144). For example, on a parcel with an existing structure having a Structure Size of 3,582 sq. ft. (existing build=3,582 sq. ft.), and a Maximum Build Area of 10,754 sq. ft., the Opportunity Area is calculated to be 7,172 sq. ft. Using the Opportunity Area of 7,172 sq. ft., the Maximum Build Score (maximum opportunity score 128) is calculated by dividing the Opportunity Area by the Maximum Build Area of 10,754, Sq. Ft., and multiplying the result by 10, totaling 6.7 (rounded). Thus, the Maximum Build Score (or maximum opportunity score 128) is 6.7. One of ordinary skill in the art would understand that multiplying the result by 10 provides a Maximum Build Score in a range of 0 to 10. In an embodiment, the result is not multiplied by 10, and the Maximum Build Score is in a range of 0 to 1. Other scaling techniques are possible while remaining within the scope of the present invention.

The renovation opportunity score 130 is calculated similarly to the Maximum Build Score, and utilizes the following equations:

$$Opportunity Area = Max Renovation Area - Structure Size$$

$$Maximum Renovation Score = ( \frac{Opportunity Area}{Max Renovation Area} ) \times 10$$

The Opportunity Area is calculated by subtracting the Structure Size (e.g., existing build from specifications table 138) from the Maximum Renovation Area (e.g., maximum renovation area 146). For example, on a parcel or lot with an existing Structure Size of 3,582 sq. ft. (existing build=3,582 sq. ft.) and a Maximum Renovation Area of 8,961 sq. ft., the Opportunity Area is calculated to be 5,379 sq. ft. The add-on area 148 is a field showing the Opportunity Area of 5,379 sq. ft. in an embodiment. Using the Opportunity Area of 5,379 sq. ft., the Maximum Renovation Score (i.e., maximum renovation score 146) is calculated by dividing the Opportunity Area of 5,379 sq. ft. by the Maximum Renovation Area of 8,961 sq. ft., and multiplying the result by 10, totaling 6.0 (rounded). Thus, the Maximum Renovation Score is 6.0 (e.g., renovation opportunity score 130). The renovation opportunity score 130 is used to specify the amount of square footage available for a renovation build.

Referring now to FIG. 3, there is disclosed the title 122, the subject address 124, a slope analysis 154, a 3D slope analysis graphic 156, a slope band table 158, slope band calculations 160, a 2D heat map 162, a heat map legend 164, a RFAR bonus 166, a RFAR bonus calculation 168, a RFAR potential renovation table 170, a maximum allowable renovation build 172, a preexisting structure area 174, and a maximum add-on area 176.

The slope analysis 154 in combination with the 3D slope analysis graphic 156 illustrates the effect that the slopes (e.g., percentage incline/decline of a portion of the parcel) have on the buildable area of the parcel or lot. The 3D slope analysis graphic 156 is generated using the slope band calculations 160. The slope bands are based on allowable RFAR relative to the percentage of slope to provide the total maximum allowable build. For example, the slope band calculations 160 may calculate slope bands for six percentages of slope, 0-14.99%, 15-29.99%, 30-44.99%, 45-59.99%, 60-99.99%, and 100+. Table 1, as shown below, is an exemplary depiction of the slope band table 158 in combination with the slope band calculations 160.

TABLE 1
Single Family Zone (Hillside Area) RFAR Calculations

| Slope (%) | Area (Sq. Ft.) | RFAR |
|---|---|---|
| 0-14.99 | 0 | 0 |
| 15-29.99 | 4,908 | 1,473 |
| 30-44.99 | 6,327 | 1,582 |
| 45-59.99 | 23,668 | 4,734 |
| 60-99.99 | 7,822 | 1,173 |
| 100+ | 0 | 0 |

Total: 8,961 Sq. Ft.

The 2D heat map 162 is a graphical two-dimensional illustration of the slope using a color-coded (or greyscale) 2D image. The colors (or greyscale) of the slope bands are displayed per the heat map legend 164, which correspond to the slope band percentages in Table 1 above. The user is able to view the slope bands overlayed on the actual property to understand where the elevation of the parcel is steepest. Using the table's RFAR slope band calculations, the user is also able to see where the square footage of the construction will be concentrated.

The RFAR bonus 166 and the RFAR bonus calculation 168 are identified to communicate to the user any relevant city or county (or land use) code that may apply to provide a bonus number of square feet, as a zoning (or land use) incentive for building on the property. For example, the RFAR bonus 166 may specify LAMC 12.21 C. 10-3 as an existing code regulation for new construction (i.e., not for renovation purposes). The RFAR bonus calculation 168 may specify the total of the slope band calculations from Table 1, the bonus (preferably expressed as a percentage) of 20%, and the total maximum build allowance of 10,754 sq. ft. The RFAR potential renovation table 170 preferably sets forth the maximum allowable renovation build 172 (e.g., the total of the slope band calculations 160 of 8,961 sq. ft., not including a new construction bonus), the preexisting structure area 174 (e.g., 3,582 sq. ft.), and the maximum add-on area 176 (e.g., 5,379 sq. ft.). The RFAR bonus calculation 168 total is input into the maximum build area 144, the maximum renovation build 172 is input into the maximum renovation area 146, and the maximum add-on area 176 is input into the add-on area 148 (as shown in FIG. 2). One of ordinary skill in the art would understand that these values are calculated in accordance with the disclosure associated with FIG. 3, and then provided in FIG. 2 for the user to identify in connection with the overall build calculations.

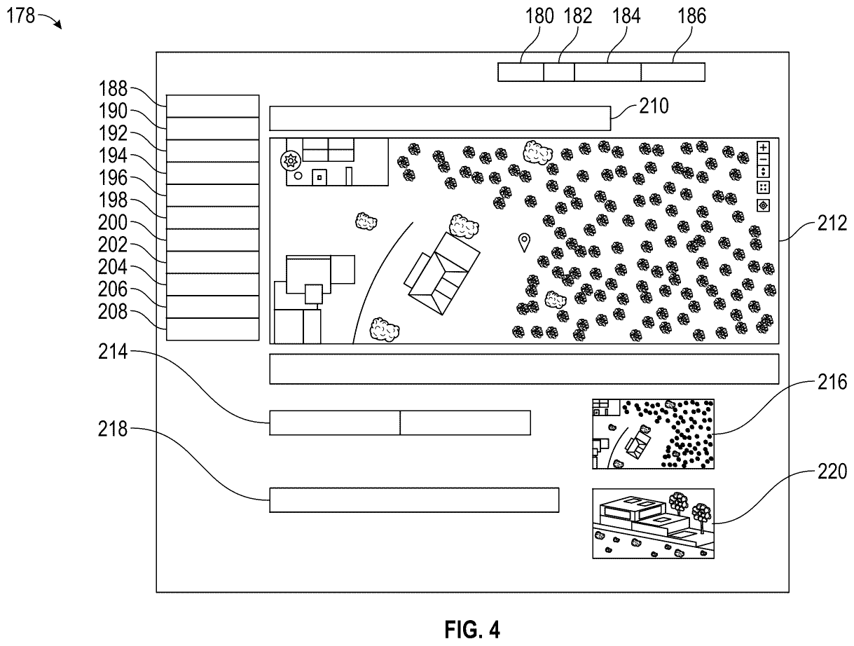

FIG. 4 illustrates an exemplary graphical user interface 174 (e.g., user interface 118) in accordance with a preferred embodiment of the present invention. This figure shows the options and graphical tools/inputs that a user of the application (e.g., application platform 106) can use to generate the feasibility analysis and/or opportunity report. FIG. 4 provides textual explanations of the various features of the graphical user interface and the purpose for each of the options and graphical tools/inputs provided by the interface. One of ordinary skill in the art would understand that a variety of methodologies may be implemented to provide a graphical user interface within the scope of the present invention. In a preferred embodiment, FIG. 4 includes a main dashboard 180, a search tool 182, a geographic location 184, a feasibility analysis tool 186, and opportunity report tools 188-208 configured to set up an eleven page opportunity report, as disclosed herein. The theme tool 188 is configured to generate a summary page of the subject property and contents of the opportunity report. The theme tool 188 preferably generates a first page of the opportunity report (e.g., a cover page) that includes the address of the subject property, the names of the author and recipient, images of the current property, and a vision rendering of a proposed development. The vision rendering is provided to give a visual context for the proposed type of development that the author recommends would work best for the geographic area. The feasibility analysis tool 190 preferably includes instructions and inputs to generate a feasibility analysis (e.g., FIGS. 2-3; third and fourth pages of opportunity report), the contents of which will be utilized for other portions of the opportunity report as needed. The acquisition comp search tool 192 includes parameters and inputs to find and investigate various comps in the area specified. The choice of comps will assist in determining a sales price for the initial acquisition. The application platform 106 permits the user to designate a search area on a map, select or deselect comps desired to be used, and provides the user with all property profile details for comps using the acquisition comp search tool 192. The acquisition comps tool 194 includes the comps selected from the acquisition comp search tool 192 and provides a matrix for comparison. The matrix preferably creates averages across different criteria to determine how the comp properties compare and how the neighborhood market performs. Off-market properties not provided in MLS are able to be manually entered using the acquisition comps tool 194. Alternatively, the application platform 106 provides the off-market properties as options to be added to the comp comparison matrix. A summary of the averages across the comp properties is preferably provided, which includes the number of comp properties, average lot size, average structure size, average price, average PPSF, and average days-on-market (DOM), as available. The exit comps tool 196 utilizes the results from the acquisition comp search tool 192 and the acquisition comps tool 194 and provides filters to narrow down criteria to represent a preferred highest and best use of a renovated or new construction project. The exit comps tool 198 prompts the user to finalize and compile all comp properties. The exit comps drilled tool 200 narrows the finalized comp properties to 1-3 selected comps from “sold” comps to represent the sold properties to best represent the suggested type, size, and style of project. The exit comps drilled tool 200 provides substantially the same summary of averages across the “drilled down” comps and are used by the application platform 106 in providing finished PPSF, for example, in new construction proforma portions of the opportunity report.

The new build analysis tool 202 provides inputs and selectable parameters to generate analysis used in the new construction proforma portions of the opportunity report, as needed. For example, the new build analysis tool 202 includes characteristics of the subject property (including address, bedrooms, bathrooms, square footage, and maximum build score, among other things), and prepopulated financial analysis based on the projected new construction. These fields are editable to allow the user to fine tune the sales price, costs, and other expenses associated with new construction. For example, a user may wish to reduce the finished square footage of the proposed new construction, which may have an impact on the remaining fields associated with the new construction (e.g., direct and indirect expenses). A final investment analysis is provided that includes the total of direct expenses, indirect expenses, gross profit, ROI, and annual IRR. Similarly, the rehab analysis tool 202 provides inputs and selectable parameters to generate analysis used in rehab/renovation proforma portions of the opportunity report, as needed. Both proformas include line items for holding costs associated with a loan or other financial vehicle to factor that cost into the analysis. The vision renderings tool 206 provides selectable choices to provide “target” options for the application platform 106 to use in generating visual renderings of new or renovation builds on the subject property. The summary tool 208 provides a prepopulated textual description based on the choices and parameters selected in the prior tool options, and permits the user to edit the descriptive text to best fit the scenario envisioned by the user.

The gallery view tool 214 provides map views of the subject property or the option to upload other preferred images. The currently selected map 216 is provided to graphically illustrate the map that will be utilized in the opportunity report. The property vision tool 218 provides rendered construction views of the subject property or the option to upload other preferred images. The currently selected rendering 220 is provided to graphically illustrate the suggested construction that will be shown in the opportunity report.

In an embodiment, in connection with the feasibility analysis disclosed in connection with FIGS. 2-3, client agents are trained to “think like a developer” to produce an opportunity report, and to be able to explain it to clients (sellers, buyers, developers). In an embodiment, homeowners are contacted through various methods to present the concept of “hidden value” and provided explanations of the opportunity reports and valuation methodologies implemented in the report to homeowners. The opportunity report may be utilized to identify projects for agents, analyzing MILS properties for clients, and providing lead-generation services for agents, and identifying the future hidden value of unlisteds, expireds, and FSBO properties.

The application platform creates succinct and graphic analyses, including opportunity reports, for the eventual future evaluation, sale or educational experience. In a preferred embodiment, the feasibility analysis provides a very detailed explanation of the current property characteristics, the property's future value characteristics, including maximum build score/renovation build score and zoning/building code narratives, and 3D proprietary graphic images of the property, including slope band calculations with all the property overlays mentioned herein.

In a preferred embodiment, the application platform produces a more in-depth opportunity report that uses all of the above-mentioned algorithms and includes the feasibility analysis, in addition to other elements described below. As mentioned herein, the feasibility analysis informs the user of the maximum build opportunity (and when appropriate, a maximum renovation opportunity) and provides a slope analysis. The opportunity report preferably is a complete report that incorporates the information produced by the feasibility analysis and integrates it into a larger and more complete market and development analysis. One of the purposes may be to determine a highest and best use for the property and a preferred way to leverage the value-add opportunities within the current marketplace. Developers typically do not want to be a pioneer in an area; they want proof of concept and a reasonable way to anticipate their project costs, timelines and potential profit. The application platform preferably looks at other newly developed or renovated properties in the area to help determine the most advantageous project scope, style, size and exit price once completed. This informs a financial analysis to determine investment viability. A financial pro-forma for new construction and another for renovation projects allows a user to compare different approaches to a project to compare costs, timelines and projected profits. This approach generates a “future development value.” Knowing the larger context of the “future development value” is critical for the buyer/seller/investor for planning. The opportunity report may be utilized to educate the seller on this hidden value in their home, not because they are going to build it themselves, but so that they can negotiate a better sales price based on the margins they understand a developer may theoretically make. The opportunity report includes the feasibility analysis, acquisition sold comps for the existing property, sold comps for the projected new home to determine best style, size and pricing, vision renderings of the type of project that fits the market, financial pro-forma for new construction, and financial pro-forma for renovation. In addition, the opportunity report may include bedroom/bathroom count, desired amenities in a particular market place such as theatres, gyms, wine cellars, catering kitchens, games rooms that may be considered must-haves in one neighborhood but not standard for others. The opportunity report may also take into account architectural style and amenities that fit the market and relative costs. For example, a luxury new build in the Hollywood Hills with a glass and steel modern architectural style will cost significantly more to build, and the proforma analysis will account for these cost estimations.

In a preferred embodiment, the opportunity report preferably provides “like-for-like” statistics of the current MLS sold and pending data sets that facilitates searches for the current properties acquisition comparable. Once received, the opportunity report then permits the user to choose the “like-for-like” property acquisition comps, based on the existing property's characteristics. The opportunity report preferably will calculate price per square foot, days on market, and other property metrics, which provides an accurate acquisition valuation of the property. Stated differently, starting with market comps, the owner (or others) can estimate the potential margin a developer will make with the property and factor in that margin to better negotiate a purchase price for the property.

In an embodiment, the opportunity report permits a similar type of search focusing on current exit comps based on the application platform's maximum square foot calculations, and analyzes the market to anticipate the value of a new development project once completed by performing the similar type of search. Stated otherwise, the opportunity report searches current MLS “sold” and “pending” properties for the property's “exit” value. Once the properties are identified, the opportunity report preferably provides the user with an option to choose the “like-for-like” comparable. This will give an accurate price per square foot to provide development and/or renovation financial pro formas. This exit comp search communicates the “sweet spot” for what should be developed. For example, if the subject property includes a very large lot compared to others in the neighborhood and the feasibility analysis indicates that a developer may build 10,000 Sq Ft, but the exit comps may indicate that no other comparable properties have sold over 5,500 Sq Ft, then the developer may conclude that the build should be within the range of 5,500 Sq Ft. Building too much more than that means they spend too much to build a huge house, in a market that doesn't support it and ultimately, which may indicate diminishing returns. The same analysis may be applied to bedroom count and other amenities. A developer typically will study other new developments in the area to get a grasp of their strategy. Thus, the Drilled Down Comps in the exit comps help take into account these other factors so that the owner (or others) may make an informed decision to capture the potential highest profit.

The opportunity report preferably automatically generates a financial proforma that calculates the possible and future build allowances and sales profit margins, which in turn calculates the return on investment (ROI) and/or the internal rate of return (IRR) for the buyer or potential investor. These metrics help identify a property's potential that may be hidden from traditional methodologies of valuing and comparing properties for purchase and sale.

The opportunity report, through the application platform, calculates these metrics by taking into account direct expenses, indirect expenses, and the final property analysis. The application platform preferably accounts for possible and/or allowable finished square footage, previously calculated price-per-square footage, a project “hold period”, including a 10% buffer, the current property's acquisition price (after running the comparables), all new building costs based on the property's location (e.g., hillside cost and individual builder costs may vary), average inspection costs, architect fees based on a percentage of the build cost, exit staging costs calculated by a price per square foot, general contractor cost based on a percentage of the build cost, initial property taxes for the entire build and hold period, buyer taxes by a percentage at initial closing of escrow, and insurance costs through the duration of the build. Indirect costs that may be accounted for include seller closing costs, including escrow charges by a percentage, lending fees by a percentage (if applicable), and agent and brokerage fees by an agreed-upon sales percentage. Costs fields are preferably auto-populated with default figures. The maximum allowable square footage for new build and renovation are preferably auto-populated from the feasibility analysis, while acquisition and exit price-per-square-foot (“PPSF”) figures are preferably auto-populated from the comp searches. Notably, all fields are editable while the formulas are editable by the user to account for specific use cases. The financial proformas preferably are based on a cash-on-cash analysis, as every investor has different ways to leverage their money and cost of money. However, the financial proforma includes a line item for Hard Money Hold Costs (default set to zero), which may be input in order to factor in these types of costs when necessary.

The opportunity report preferably generates nine vision (e.g., graphical) renderings of the proposed property that the agent deems the best fit for the future site and/or lot. This feature may be automatic or manual. The opportunity report also includes automated pages including the executive summary, area overview, existing property condition, personal project description, the previously provided feasibility analysis, acquisition comparable, final exit and drill down comparable, exit and planning financials for a new build and a remodel, and a final conclusion and agent summary. Preferably the opportunity report also includes a broker's disclosure as per applicable laws.

An exemplary opportunity report in accordance with a preferred embodiment of the present invention includes eleven pages. The opportunity report is preferably generated by the application platform 106. The first page includes a photo of the subject property (e.g., satellite photo, aerial map view, street view, or other photo), a vision rendering of the proposed type of project, and the names of the person for whom the report was prepared and the report creator. The report creator generates the vision rendering preferably by utilizing the application platform 106 to choose from galleries of house styles, architectural style, topography and amenities representations, etc.

The second page includes an Executive Summary, an Area Overview, an Existing Property Description, and a Project Description. The Executive Summary identifies the key points to help the reader use and understand the opportunity report. The Area Overview is a description of the area in which the parcel/property is located. The Existing Property Description is a description of the structure of the house, lot size, zoning, and other information. The Project Description describes the future development potential. Key metrics are dynamically retrieved from the feasibility analysis, the acquisition and exit comp searches and the financial proforma for speed and consistency. However, all content can be edited by the user to provide more background and vision to a project and/or to customize the report for the intended recipient. Area descriptions may be loaded into the software and dynamically retrieved for the opportunity report based on zip code.

The third and fourth pages includes the feasibility analysis, as shown in FIGS. 2-3, and generated using the application platform 106. As an example (different from the example described in connection with FIGS. 2-3), the Opportunity Area is calculated by subtracting the Structure Size from the Maximum Build Area. Thus, on a parcel with an existing structure with a Structure Size of 2,314 sq. ft., and a Maximum Build Area of 9,035 sq. ft., the Opportunity Area is calculated to be 6,721 sq. ft. Using the Opportunity Area of 6,721 sq. ft., the Maximum Build Score is calculated by dividing the Opportunity Area by the Maximum Build Area of 9,035 sq. ft., and multiplying the result by 10, totaling 7.4 (rounded). Thus, the Maximum Build Score is 7.4.

In addition, the Renovation Build Score may be calculated in the above example. For example, on a parcel with an existing structure with a Structure Size of 2,314 sq. ft., and a Renovation Area (the maximum allowable renovation size) of 7,529 sq. ft., the Opportunity Area is calculated to be 5,215 sq. ft. Using the Opportunity Area of 5,215 sq. ft., the Maximum Renovation Score is calculated by dividing the Opportunity Sq. Ft. from the Renovation size of 7,529 Sq. Ft., and multiplying the result by 10, totaling 6.9 (rounded). Thus, the Renovation Build Score is 6.9.

The fifth page includes vision renderings of the proposed new property, generated by the report creator using the application platform 106. The vision renderings may utilize a variety of architectural styles. The vision renderings illustrate examples of the construction/build, but also how the property will look in connection with the parcel's topography.

The sixth page includes acquisition comps for homes with similar style, size, and age. The software interface/application platform 106 permits the report creator to select the area and adjust filters to identify comparable properties, including house and lot size, house age, time period for area sales, etc. The application platform 106 also permits the report creator to identify off-market properties. The bottom matrix dynamically averages the selected comps to provide an easily readable summary for the user.

The seventh page includes exit comps for homes with similar style, size, and age. The software interface/application platform 106 permits the report creator to select the area and adjust the filters to find properties that have a similar size as represented in the feasibility analysis. The matrix may be provided that dynamically averages the selected comps. The exit comps helps identify a “sweet spot” and determine the most desirable house size, bedroom count, etc., and compare the prices they demand. For example, the feasibility analysis may indicate that an 8,000 sq. ft. build may be accomplished, but the sold comps indicate that the highest PPSF homes are 5,000 sq. ft., alerting the user that an 8,000 sq. ft. build may be an overdevelopment of the property and diminish the property's returns.

The eighth page includes drilled down comparisons for size, land, and house. The drilled down comps assist the report creator to illustrate with real-life examples the kind of homes that have been built and sold. The pricing metrics are auto-populated into the financial pro-formas, and can be edited.

The ninth page includes exit planning and financials for the finished project. The exit planning and financials is a new construction pro-forma including a property profile (including a projected sales price, finished square foot, price per square foot, projected hold period, and hold period buffer %). The PPSF is dynamically pulled from averages of the drilled-down comps, and can be edited. One of ordinary skill in the art would understand that the PPSF may be stored in the mySQL database 108 and utilized by the application platform 106. The exit planning and financials includes a direct expense percentage, i.e., direct expenses that relate to the cost to acquire the property and build it, more fully described herein, that includes a purchase price, a new build cost, a new build cost buffer (e.g., 5%), inspections costs, architect fees, staging costs, GC fee, property tax (e.g., for entire hold period), a buyer purchase closing cost, an insurance cost (based on hold period with buffer), and the total. The exit planning and financials includes indirect expenses (e.g., additional costs such as costs to sell the finished project and loan carrying costs), including as seller closing cost from sale of home, hold costs hard money, brokerage sales commission, and the total. The exit planning and financials include cash-on-cash ROI and IRR, including direct expense, indirect expense, the total, and the gross profit (e.g., the projected sales price minus the total expenses). Finally, the exit planning and financials includes an ROI calculation and an IRR calculation.

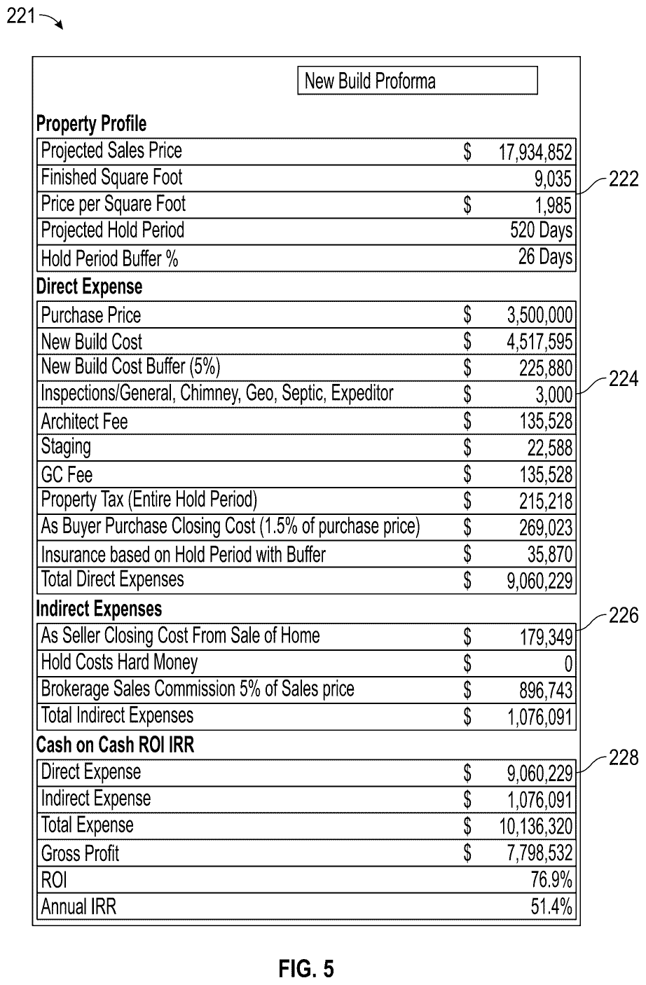

Referring now to FIG. 5, there is disclosed an exemplary new build proforma 221 providing exit planning and financials to the user (e.g., ninth page of opportunity report). The new build proforma 221 includes a property profile 222, a direct expense table 224, an indirect expense table 226, and a cash-on-cash ROI and IRR table 228.

The property profile 222 includes a projected sales price of $17,934,852, a finished square footage of 9,035, a PPSF of $1,985, a projected hold period of 520 days, and a hold period buffer percentage of 26 days. As disclosed herein, the finished square footage is obtained from the feasibility analysis (e.g., Maximum Build Area of 9,035; see maximum build area 144). In addition, the PPSF is obtained from the exit comps drilled tool 200. The property profile 222 generally provides the overall finished project including its sales price, size, and timeline to complete.

The direct expense table 224 includes a purchase price of $3,500,000, a new build cost of $4,517,595, a new build cost buffer of $225,880 (e.g, 5%), inspections costs of $3,000, an architect fee of $135,528, a staging cost of $22,588, a general contractor fee of $135,528, a property tax cost of $215,218 (e.g., entire hold period of 546 days), an as-buyer purchase closing cost of $269,023 (e.g., 1.5% of purchase price), an insurance cost of $35,870 (e.g., based on hold period with buffer of 546 days), and a total direct expense of $9,060,229. Preferably, the new build cost is a product of the finished PPSF and an editable field for cost PSF. The purchase price is either manually provided by the report creator or automatically obtained from the mySQL database 108 from the MLS sales price.

The indirect expense table 226 includes an as-seller closing cost from sale of home of $179,349, hold costs of $0 (e.g., default=$0, but can be manually adjusted based on loan or hard money), brokerage sales commission cost of $896,743 (e.g., 5% of sales price), and a total indirect expense of $1,076,091. Preferably, the indirect expenses are costs associated with selling the finished project and any financing costs associated with carrying the property.

The cash-on-cash ROI and IRR table 228 includes direct expenses of $9,060,229, indirect expenses of $1,076,091, total expense of $10,136,320, and gross profit of $7,798,532. The direct and indirect expenses are obtained from the direct and indirect expense tables 224, 226. The gross profit is calculated by subtracting the total expenses from the projected sales price. The table 228 also includes an ROI calculation of 76.9% and an annual IRR of 51.4%. The ROI is calculated by dividing the gross profit from the projected sales price, rendered as a percentage. The annual IRR is calculated based on factoring the ROI against time.

The tenth page of the opportunity report includes exit planning and financials including a pro-forma for a renovation/rehab build and may include all or portions of the same or similar information as provided in connection with the ninth page, except that the costs are associated with a renovation or rehabilitation build rather than a new construction build. For example, substantially the same information and format as depicted in FIG. 5 is used to provide the proforma for a renovation/rehab build.

The eleventh page includes a Conclusion/Summary of all of the main points covered in the feasibility analysis, including automated preloaded conclusions for the user of the report. The report creator's information is listed on the bottom of the Conclusion/Summary page.

Please refer to an opportunity report as provided in connection with U.S. Provisional Patent Application No. 63/404,901.

Referring now to FIG. 6, there is provided an exemplary real estate feasibility analysis method 230 in accordance with a preferred embodiment of the present invention.

At Step 232, elevation data of a geographical location is received. Preferably, the elevation data includes altitude contours defined by horizontal and vertical coordinates within the geographical location. The altitude contours are preferably segregated by altitude intervals. As described herein, the elevation contours may be segregated into a number of altitude intervals, including 2, 3, 4, 5, 6, or more intervals. The altitude intervals preferably include elevation ranges such as 3, 10, 15, etc., feet, and may be configured to relate to municipal, city, or county codes as required.

At Step 234, parcel information is received. The parcel information preferably includes coordinate information defining boundary and structure information associated with the parcel and any structures thereon. The parcel information also may include parcel regulations including at least one of zoning parameters, residential floor area ratio regulations, lot coverage restrictions, setback regulations, land use regulations, height restrictions, map-based boundary data, property ownership data, building footprint data, interior room boundary data, assessor data, and multiple listing service data, as more fully described herein. Depending on the output of the method, some or all of the parcel information described herein may be utilized for algorithmic calculations and/or display to a user.

At Step 236, the parcel is determined to be located within the geographical location. The parcel information is preferably utilized to determine that the boundary and structure information (preferably defined by horizontal and vertical coordinates) corresponds to the coordinate information of the elevation data. The parcel typically is located within a specified geographical location such that the parcel is wholly located within the geographical location and thus, the elevation data and the parcel information may be directly compared. In the event that this is not true, then more than one set of elevation data may be utilized to compare against the parcel information.

At Step 238, the elevation data is converted to elevation slope bands for each of the altitude contours associated with the parcel. As shown in FIG. 6, the altitude contours at Step 240 are input such that the particular altitude contours (e.g., part of the parcel information) are compared and matched with the elevation data. At Step 242, slope band parcel ratios of the parcel are determined. Preferably, the slope band parcel ratios are determined using the parcel information and the elevation slope bands. As described above, the altitude contours are matched against the elevation data such that the ratios identify a percentage of area of the parcel associated with each of the elevation slope bands.

At Step 244, a maximum buildable area is determined using the slope band parcel ratios. At Step 246, parcel regulations and zoning incentives are provided. At Step 244, using the parcel information and the zoning incentives, the maximum buildable area may be increased or reduced. For example, if the zoning regulations prohibit building above a certain square footage, or otherwise prohibit building, including height restrictions, historic districts, etc., then the maximum buildable area is reduced in a magnitude corresponding to the restriction. In another example, the zoning incentives may provide a construction build bonus (e.g., 10%, 20%, etc.) such that the maximum buildable area is increased based on the magnitude of the bonus.

At Step 248, new construction and/or renovation data is provided. This is an input provided by the user; the user may be interested in a new construction build or a renovation build, or wishes to compare the two. In an embodiment associated with Step 248, a new construction buildable area is determined in a scenario where the user contemplates demolishing the existing structure and building new construction on the parcel. In another embodiment associated with Step 248, a renovation buildable area is determined where the user contemplates adding onto the existing structure. Both of these scores may be determined at Step 244.

At Step 250, a maximum opportunity area associated with the parcel is determined. Preferably the maximum opportunity area is the difference between the maximum buildable area (from Step 244) and the structural area determined from the structure coordinates of the parcel. At Step 252, the structural area is provided for use at Step 250. For a new construction build, the maximum opportunity area represents the new construction and the value-add represented by the new construction (assuming demolition of the structural area). For a renovation build, the maximum opportunity area represents the renovation build and the value-add represented by the add-on potential (assuming that the structural area is not demolished and/or is not completely demolished).

At Step 254, a maximum build score associated with the parcel is determined. Preferably, the maximum build score is determined from the maximum buildable area and the maximum opportunity area, and represented by a ratio of the maximum opportunity area to the maximum buildable area. This algorithmic calculation, as disclosed herein, provides the user with a way in which to determine the opportunity presented by the new construction (e.g., maximum build score 128) or the renovation (e.g., renovation build score 130) of the parcel.

At Step 256, a feasibility analysis is provided to the user. The feasibility analysis is described in detail herein, and preferably includes the maximum build score 128, 130. At Step 258, the ROI and annual IRR are determined and provided to the user. The ROI and annual IRR are described in detail herein, and preferably are determined using the maximum build score 128, 130, among other data as appropriate. The ROI and annual IRR are part of a more comprehensive opportunity report, as more fully described herein. As described herein, the feasibility analysis and opportunity report, or any portion of each, may be displayed to the user using the user interface 118. The display may be configured to provide at least one of the maximum build score and at least a portion of the parcel information, and a three-dimensional representation of the parcel and the slope bands parcel ratios, among other data suitable to provide to a buyer, seller, agent, or developer of real estate.

The method 230, or only certain steps of the method 230, are preferred embodiments in accordance with the present invention. For example, the maximum buildable area may be provided, which may be input to the feasibility analysis and/or opportunity report without calculating a maximum opportunity area and/or a maximum build score. Other examples are possible without departing from the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present disclosure, are stored or recorded on a hard disk or other like storage devices described above, which may be accessed and utilized by a web browser, mobile app, the server (over the network), or any of the peripheral devices described herein. One or more of the modules or steps of the present disclosure also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present disclosure could be accomplished with standard programming techniques with logic to accomplish the various steps in accordance with the present disclosure described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C #, Java, Cobol, assembler, PERL, Python, PUP, or the like, or macros using Excel or other similar or related applications with various algorithms being implemented with any combination of data structures, objects, processes, routines or other programming elements.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges. It will be appreciated that any dimensions given herein are only exemplary and that none of the dimensions or descriptions are limiting on the present invention.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

1. A real estate feasibility analysis method comprising the steps of
receiving elevation data corresponding to a geographical location, wherein the elevation data comprises altitude contours defined by horizontal and vertical coordinates within the geographical location,
receiving parcel information comprising coordinate information defining boundary and structure information associated with the parcel and any structures thereon,
determining that a parcel of real property is located within the geographical location using the parcel information,
converting the elevation data to elevation slope bands for each of the altitude contours associated with the parcel,
determining slope band parcel ratios of the parcel using the parcel information and the elevation slope bands, wherein the slope band parcel ratios indicate a percentage of area of the parcel associated with each of the elevation slope bands,
determining a maximum buildable area using the slope band parcel ratios of the parcel.

2. The method of claim 1 further comprising
determining a maximum opportunity area associated with the parcel, wherein the maximum opportunity area comprises the difference between the maximum buildable area and a structural area determined from the structure coordinates of the parcel.

3. The method of claim 2 further comprising
determining a maximum build score associated with the parcel, wherein the maximum build score is represented by a ratio of the maximum opportunity area to the maximum buildable area.

4. The method of claim 3 further comprising displaying at least one of the maximum build score, at least a portion of the parcel information, and a three-dimensional representation of the parcel and the slope bands parcel ratios.

5. The method of claim 1 wherein the parcel information further comprises parcel regulations including at least one of zoning parameters, residential floor area ratio regulations, lot coverage restrictions, setback regulations, land use regulations, height restrictions, map-based boundary data, property ownership data, building footprint data, interior room boundary data, assessor data, and multiple listing service data.

6. The method of claim 1 wherein the parcel information further comprises parcel regulations, and wherein the slope band parcel ratios are reduced by a magnitude to which the parcel regulations restrict building on the slope band parcel ratios, for each of the slope band parcel ratios.

7. The method of claim 1 wherein the parcel information further comprises zoning incentives, and wherein the slope band parcel ratios are increased by a magnitude to which the zoning incentives permit additional building on the slope band parcel ratios, for each of the slope band parcel ratios.

8. The method of claim 1 further comprising
determining return on investment data and annual internal rate of return based at least in part on the maximum buildable area, and
providing an opportunity report comprising at least one of the return on investment data and the annual internal rate of return.

9. The method of claim 1 wherein the elevation data is segregated by altitude interval.

10. A real estate feasibility analysis system comprising:
a geospatial data server configured to receive and publish parcel information comprising coordinate information defining boundary and structure information associated with the parcel and any structures thereon,
an elevation data converter configured to receive elevation data corresponding to a geographical location, wherein the elevation data comprises altitude contours defined by horizontal and vertical coordinates within the geographical location, to generate elevation slope bands from the elevation data, and to provide the elevation slope bands to the geospatial data server,
a real estate analysis engine configured to receive the parcel information and the elevation slope bands from the geospatial data server, determine that a parcel of real property is located within the geographical location using the parcel information, determine slope band parcel ratios of the parcel using the parcel information and the elevation slope bands, wherein the slope band parcel ratios indicate a percentage of area of the parcel associated with each of the elevation slope bands, and determine a maximum buildable area using the slope band parcel ratios of the parcel.

11. The real estate feasibility analysis system of claim 10 wherein the real estate analysis engine is further configured to determine a maximum opportunity area associated with the parcel, wherein the maximum opportunity area comprises the difference between the maximum buildable area and a structural area determined from the structure coordinates of the parcel.

12. The real estate feasibility analysis system of claim 11 wherein the real estate analysis engine is further configured to and determine a maximum build score associated with the parcel, wherein the maximum build score is represented by a ratio of the maximum opportunity area to the maximum buildable area.

13. The real estate feasibility analysis system of claim 12 further comprising a display configured to provide at least one of the maximum build score and at least a portion of the parcel information, and a three-dimensional representation of the parcel and the slope bands parcel ratios.

14. The real estate feasibility analysis system of claim 10 wherein the parcel information further comprises parcel regulations including at least one of zoning parameters, residential floor area ratio regulations, lot coverage restrictions, setback regulations, land use regulations, and height restrictions, map-based boundary data, property ownership data, building footprint data, interior room boundary data, assessor data, and multiple listing service data.

15. The real estate feasibility analysis system of claim 10 wherein the parcel information further comprises parcel regulations, and wherein the slope band parcel ratios are reduced by a magnitude to which the parcel regulations restrict building on the slope band parcel ratios, for each of the slope band parcel ratios.

16. The real estate feasibility analysis system of claim 10 wherein the parcel information further comprises zoning incentives, and wherein the slope band parcel ratios are increased by a magnitude to which the zoning incentives permit additional building on the slope band parcel ratios, for each of the slope band parcel ratios.

17. The real estate feasibility analysis system of claim 10 wherein the real estate feasibility engine determines return on investment data and annual internal rate of return based at least in part on the maximum build score, and provides an opportunity report comprising at least one of the return on investment data and the annual internal rate of return.

18. A real estate feasibility analysis method comprising the steps of
receiving elevation data corresponding to a geographical location, wherein the elevation data comprises altitude contours defined by horizontal and vertical coordinates within the geographical location,
receiving parcel information corresponding to a parcel of real property located within the geographical location, the parcel information comprising coordinate data defining boundary and structure information associated with the parcel and any structures thereon, zoning parameters, residential floor area ratio regulations, lot coverage restrictions, setback regulations, land use regulations, height restrictions, map-based boundary data, property ownership data, building footprint data, interior room boundary data, assessor data, and multiple listing service data, converting the elevation data to elevation slope bands for each of the altitude contours associated with the parcel,
determining slope band parcel ratios of the parcel using the parcel information and the elevation slope bands, wherein the slope band parcel ratios indicate a percentage of area of the parcel associated with each of the elevation slope bands, wherein the slope band parcel ratios are reduced by a magnitude to which the parcel regulations restrict building on the slope band parcel ratios, for each of the slope band parcel ratios,
determining a maximum buildable area using the slope band parcel ratios of the parcel,
determining a maximum opportunity area associated with the parcel, wherein the maximum opportunity area comprises the difference between the maximum buildable area and a structural area determined from the structure coordinates of the parcel,
determining a maximum build score associated with the parcel, wherein the maximum build score is represented by a ratio of the maximum opportunity area to the maximum buildable area, and
displaying at least one of the maximum build score, at least a portion of the parcel information, and a three-dimensional representation of the parcel and the slope bands parcel ratios.

19. The method of claim 18 further comprising
determining return on investment data and annual internal rate of return based at least in part on the maximum build score, and
providing an opportunity report comprising at least one of the return on investment data and the annual internal rate of return.
